(19) United States
(12) Patent Application Publication
(10) Pub. No.: US 2004/0174027 A1
(43) Pub. Date: Sep. 9, 2004

(54) Device for pulling hose

(76) Inventor: Raymond E. Bennett, Wheaton, IL (US)

Correspondence Address: Robert L. Marsh, P.O. Box 4468, Wheaton, IL, 60189-4468, US

(21) Appl. No.: 10/626,286

(22) Filed: Jul. 24, 2003

Related U.S. Application Data
(60) Provisional application No. 60/431,915, filed on Dec. 9, 2002.

(51) Int. Cl. B65G 7/12

(52) U.S. Cl. 294/26

(57) ABSTRACT

A tool for pulling flexible hose includes a longitudinal arm with a handle at one end and a hook at the other end. The hook includes first and second hook ends spaced from each other by a distance at least equal to the diameter of the hose to be pulled, and first and second support surfaces near the respective first and second hook ends. The first and second support surfaces engage the outer surface of the hose as the hose is being pulled. A protrusion near either the first hook end or the second hook end retains the length of hose so as not to slide outward of the first and second hook ends while the hose is being pulled.

The applicant claims priority from his co-pending provisional application filed Dec. 9, 2002 and assigned serial No. 60/431,915.

The present invention relates to a hook useable to pull large diameter hose such as the type used to suction mud and sludge from pits below automobile washing machines or fire hose.

### BACKGROUND OF THE INVENTION

Fire hose, that is the hose used by firemen to attach to fire plugs and discharge water on a fire, is flexible and easily handled until it is inflated by water. Once the fire hose is attached to a fire hydrant, however, and the pressure of the water is released into the hose, the weight of the water within the hose multiplies its overall weight many times. Also, the pressure of the water within the hose gives the hose a rigidity similar to the rigidity obtained by the rubber of a balloon after it is inflated. When in use, fire hoses tend to be muddy and wet, which along with their weight and rigidity, makes them difficult to maneuver by hand. In fact, when one uses his hand to grasp a length of fire hose and pull the fire hose, the force of his hand against the wall of the fire hose will overcome the pressure within the hose and cause the hose to kink around his hand. The force of the pressurized liquid will then be applied on opposite sides of the fingers of the hand, thereby pinching the fingers and causing pain.

Somewhat similar problems occur when mud and sludge is pumped from the pit below a car wash pit. A car wash facility has a pit below the washing facility for collecting mud removed from the vehicles. The mud and sludge is periodically removed by pumping the sludge through a hose having a diameter of three to eight inches and collecting the sludge in a truck loaded tank for removal. In order to remove the sludge from the bottom of the pit, the end of the hose must be moved around the bottom of the pit. The hose is awkward and heavy because of the weight of the water and the sludge passing through the hose. The task is made more difficult because the surrounding concrete flooring is wet and slippery. Prior to the present invention, an operator of a pump would stand at the edge of the pit and grasp the hose with his arms and use the weight of his body to move the end of the hose around the bottom of the pit as needed to withdraw the mud and sludge from the bottom of the pit. There is, therefore, a need for an improved method of moving large diameter hose through which water or sludge is being pumped.

### SUMMARY OF THE INVENTION

Briefly, the present invention is embodied in a device for pulling a length of flexible hose having a given diameter. The device consists of an elongate arm having a first end and a second end. A handle is positioned at the first end and a hook is positioned at the second end for grasping a length of hose. The hook has a first hook end and a second hook end spaced from the first hook end by a distance at least equal to the given diameter of the hose. The hook also has a first support surface adjacent the first hook end, the first support surface being generally perpendicular to the longitudinal axis of the arm. The hook has a second support surface near the second hook end, the second support surface being generally perpendicular to the arm, and a protrusion between the second support surface and the second hook end for retaining the flexible hose within the hook while the operator uses the handle to move the hose.

### BRIEF DESCRIPTION OF THE DRAWINGS

A better understanding of the present invention will be had after a reading of the following detailed description taken in conjunction with the drawings wherein:

FIG. 1 is a side elevational view of a device for moving hose in accordance with the present invention;

FIG. 2 is an isometric view of a length of hose of the type used to remove mud and sludge from the bottom of a car wash pit or the like; and

FIG. 3 is a side elevational view of the device shown in FIG. 1 being used to move a length of hose shown in FIG. 2.

### DETAILED DESCRIPTION OF A PREFERRED EMBODIMENT

Fire hose is flexible and when not is use is easily stored as long, flexible ribbons which can be draped over holders positioned on a fire engine. Typical fire hose has a diameter of about three inches when inflated with pressurized water from a fire hydrant.

Referring to FIG. 2, a length of hose 10 of the type used to draw out mud and sludge from the bottom of a car wash pit or the like, has a rigid cylindrical wall 12 made of hard rubber or the like. The hose 10 typically has an outer diameter of three inches, four inches, six inches, or eight inches, and the outer diameter of the wall 12 typically has a spiral groove 14 therein, with the groove having a depth of approximately one-eighth to one-fourth inch. Successive spirals of the groove are spaced from one another by a distance of one-half to three-quarters inch. The spiral groove 14 gives the hose the appearance of having a plurality of small ripples 16—16 in the length of the hose, with each of the ripples 16 being the rubberized outer surface of the wall 12 between successive turns of the spiral groove 14. The hose 10 has a given diameter 18 which is typically three inches, four inches, six inches, or eight inches.

To move the hose 10, a tool 20 in accordance with the present invention is provided. The tool 20 has an elongate arm 22 defining a longitudinal axis 24. The arm 22 has a handle 26 at one end thereof and a hook 28 at the opposite end thereof. The handle 26 includes an elongate member 30 extending perpendicular to the longitudinal axis 24 sized to be easily gripped by the human hand in order that the weight of the hose 10 may be pulled by applying a force along the axis 24 of the arm 22.

The hook 28 includes a first hook end 32 at the distal end of the arm 22 and a second hook end 34 spaced from the first hook end 32 by a distance at least equal to the diameter 18 of the hose 10.

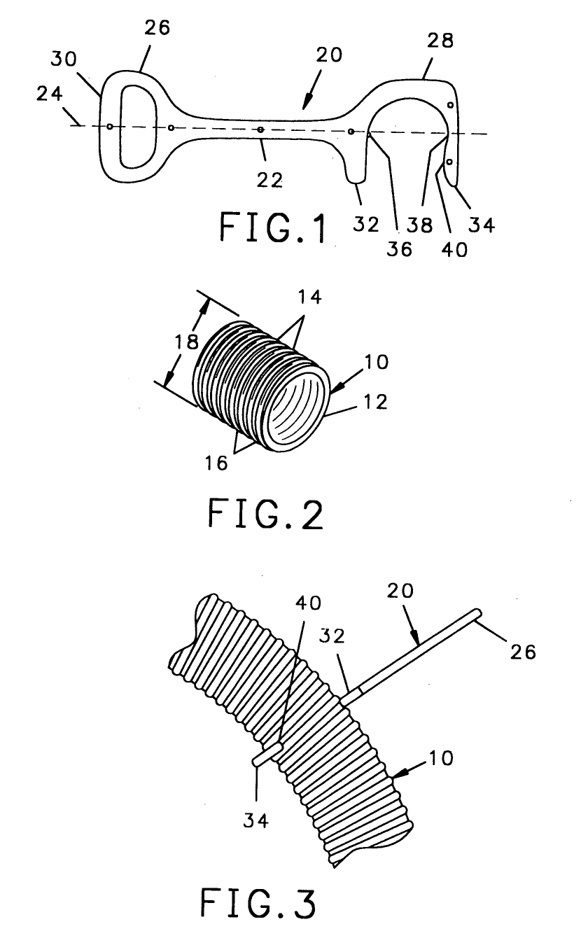

Referring to FIGS. 1 and 3, positioned adjacent the first hook end 32 is a first support surface 36 which is oriented perpendicular to the longitudinal axis 24 and at the distal end of the arm 22. Similarly, positioned near the second hook end 34 is a second support surface 38. The second support surface 38 is also oriented perpendicular to the longitudinal axis 24 and is spaced from the first support surface 36 by a distance greater than the diameter of the hose 18. Positioned between the second support surface 38 and the second hook end 34 is a protrusion 40.

As best shown in FIG. 3, in the preferred embodiment the first hook end and the second hook end are spaced from one another a distance a little greater than the diameter 18 of the hose 10 the device 20 is intended to handle. Accordingly, the hook 28 can be positioned around a length of hose 10 by sliding the first hook end 32 and the second hook end 34 around opposite sides of a length of hose 10 until the central diameter of the length of hose 10 is positioned between the first support surface 36 and the second support surface 38. Thereafter, an operator may grasp the member 30 of the handle 26 and pull. As the handle 26 is pulled, the tool 20 become skewed, that is not perpendicular to the axis of the length of hose 10 until the first support surface 32 engages the upper surface of a length of hose 10 and the second support surface 34 engages the lower surface of the length of hose 10. The protrusion 40 will retain the hose 10 between the first and second support surfaces 32, 34 while the hose 10 is being pulled. It should be appreciated that where the tool 20 is used to pull a relatively rigid hose such as the type used to remove mud and sludge from a car wash pit, the protrusion 40 may be near either the first hook end 32 or the second hook end to retain the hose 10 between the support surfaces 32, 34.

In the preferred embodiment, the tool 20 is made from sheet metal and has an overall thickness of approximately three-eighths inch. As best shown in FIG. 3, when the tool 20 is hooked around a length of hose and pulled the first and second support surfaces 32, 34 will engage the ripples between the grooves 14 on the outer wall 12 of the hose 10 and thereby prevent the tool 20 from slipping along the length of hose 10. A further pulling on the handle 26 will cause the hose 10 to be moved much more efficiently than if the hose were grasped by the arms of an operator. The tool 20 will greatly reduce the effort expended in removing the length of hose 10, especially when the hose is filled with water and sludge during the process of pumping water and sludge from a tank below a car wash facility or the like.

In the preferred embodiment, the tool 20 is cut from a plate of sheet metal and is of sufficient thickness to retain its rigidity while being used to pull a length of hose 10 having water and sludge passing therethrough. The contour of the tool 20 may be cut using any appropriate means, including a cutting process or stamping process.

While the present invention has been described with respect to a single embodiment, it will be appreciated that many modifications and variations may be made without departing from the true spirit and scope of the invention. It is therefore the intent of the independent claims to cover all such modifications and variations that fall within the true spirit and scope of the invention.

What is claimed:

1. A tool for pulling flexible hose having a given diameter comprising
an arm having a first end, a second end, and a longitudinal axis,
a handle at said first end of said arm,
a hook at said second end of said arm,
said hook having a first hook end and a second hook end spaced from said first hook end by a distance at least equal to said given diameter,
said hook having a first support surface adjacent said first hook end,
said first support surface being generally perpendicular to said longitudinal axis,
said hook having a second support surface near said second hook end,
a protrusion between said second support surface and said second hook end, for retaining said flexible hose in said hook while a user pulls on said handle.

2. A tool for pulling flexible hose having a given diameter comprising
an arm having a first end, a second end, and a longitudinal axis,
a handle at said first end of said arm,
a u-shaped hook at said second end of said arm,
said u-shaped hook having a first hook end and a second hook end spaced from said first hook end by a distance at least equal to said given diameter,
said u-shaped hook having a first support surface adjacent said fist hook end,
said first support surface being generally perpendicular to said longitudinal axis,
said hook having a second support surface near said second hook end, and
means on said second hook end for retaining said flexible hose between said first and said second support surfaces while a user pulls on said handle.

3. A tool in accordance with claim 2 wherein said means on said second hook end is a protrusion.
